(19) United States
(12) Patent Application Publication
(10) Pub. No.: US 2007/0023452 A1
(43) Pub. Date: Feb. 1, 2007

(54) Safeguard device for a liquid container pump

(75) Inventor: Kun-Lung Tseng, Taichung Hsien (TW)

Correspondence Address: John S. Egbert;Egbert Law Offices, 7th Floor, 412 Main Street, Houston, TX, 77002, US

(73) Assignee: Living Fountain Plastic Industrial Co., Ltd., Dali City (TW)

(21) Appl. No.: 11/193,191

(22) Filed: Aug. 1, 2005

(51) Int. Cl. B67B 5/00

(52) U.S. Cl. 222/153.06; 222/153.13

(57) ABSTRACT

The safeguard device for the pump of a liquid container prevents the pump of the new liquid container from being opened by the consumers. The device is a substrate that can be fastened or tied to the joint cap on the top of the bottle cap on the container, and the substrate forms a positioning chip that is connected to the pump. A disconnected line is placed between the substrate and the positioning chip, and by connecting the substrate and positioning chip to the joint cap and pump of the contain, it can maintain the unopened status of the joint cap and pump, so that the consumer can easily twist the pump open and cause it to spring up. Also, the device prevents the cleaner inside from being pumped out, and once the pump is twisted.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a safeguard device for the liquid container pump, and more particularly to a substrate that can be hooked or connected to the joint cap on top of the bottle cap of the container and the positioning chip on its upper end, and make the substrate and positioning chip connect to the joint cap and pump, and by effectively maintaining the unopened connection and pump to restrict the pump being opened easily by the consumers.

### BACKGROUND OF THE INVENTION

Conventional design of the pump of the container that contains liquid cleaner such as lotion, shampoo and conditioning mainly has a piston rod placed on the bottom of the pump, and the piston rod is placed in the cylinder on the bottom of the bottle cap of the container, and a spring is placed between the pump and the bottom of the cylinder, which gives the pump and its piston rod elastic pressure control and restore function, so that the cleaner can be pumped out, and a slot is placed on the bottom of the lower cylinder, and a reverse stopper is placed in the slot; while the pump is locked to the joint cap on top of the bottle cap, by the reverse stopper at the bottom of the piston rod to prevent the cleaner from coming out, which create the position of the pump when it is displayed for sale.

Because the pump of this type of container is simply connected to the connection set to maintain the unopened status of the pump; when it is displayed in the market, because of the curiosity or improper twist and cause the bottle to be opened, and cause the pump spring up from the support of the spring, and the cleaner comes out of bottle, because the consumers pumps it repeatedly; after the sales rep found out, just press the pump down to look like it has never been opened, and in reality, this bottle of lotion has been used; it is not fair to the consumers who spent the money and purchases the product that is used, and for the business owner, because the bottle has been opened by the customers, therefore, it can not be sold, which is not cost effective, and does not meet the principle of cost accounting.

To avoid this type of problems from happening, some business invented a safeguard for the pump, it is mainly placing a set of ring on the bottom of the pump and connection set, and the ring has corresponding gears, and one of the gears forms ring like spaced hole between it and the pump, and each hole has strip so that the gear and pump is half connected, so when the product is being displayed in the market, the locking between the pump and the joint cap relies on the connection between the gears, so that the unopened status or preferred maintenance of the pump and the connection set can be avoided by the consumers to protect the new product, and when the consumer buys it and ready to use, just twist it forcefully to break the connection between the pump and the gear parts, and continue to twist the pump to break it from its connection with the connection set, and to use by the support of the spring.

The safeguard for the pump of the container uses the connection between the gears to get the locking relation between the pump and the connection set, besides being complicated, when the consumer accidentally opens the pump, if the consumer or the sales personnel pushes the pump down, other consumers will not be able to tell the fact the pump and the gears have been broken, which caused the consumer to spend the money on the product that has been opened, and not able to protect the consumer's rights and even cause disputation; it has to be improved.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The safeguard device for the pump of the liquid container can be fastened or tied to the substrate of the joint cap on top of the bottle cap of the container and the positioning chip on the top, and connected to the joint cap and pump to maintain the locking relation between the pump and joint cap, on one hand, it can avoid the pump being opened improperly, on the other hand, it shows whether the pump has been opened improperly; the structure is simple and easy to assemble, which can effectively solve many issues existed in the conventional design. Overall, it has the industrial value and practicability, and with the new design, the patent may be applied according to the laws.

### BRIEF DESCRIPTION OF THE SEVERAL VIEWS OF THE DRAWINGS

FIG. 1 shows a structural diagram of the present invention.

FIG. 2 shows a relational structural diagram of the preferred embodiment of the present invention.

FIG. 3 shows a structural diagram of another preferred embodiment of the present invention.

FIG. 4 shows a relational structural diagram of another preferred embodiment of the present invention.

FIG. 5 shows a structural view of another preferred embodiment of the present invention.

FIG. 6 shows a relational structural diagram of another preferred embodiment of the present invention.

FIG. 7 shows a structural view of another preferred embodiment of the present invention.

FIG. 8 shows a relational structural diagram of another preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

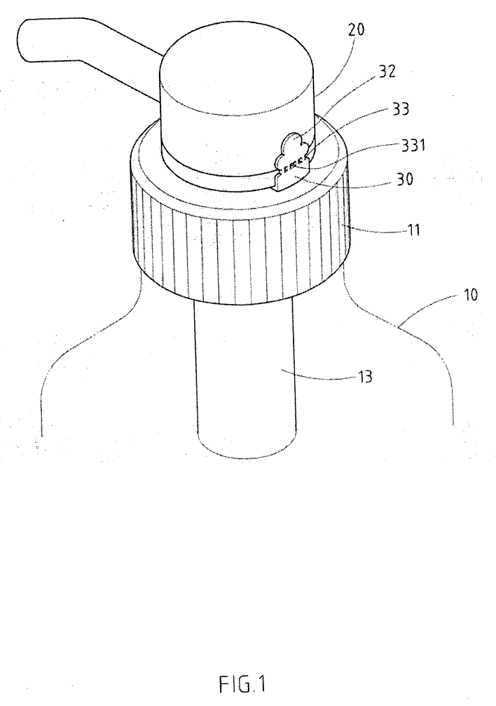

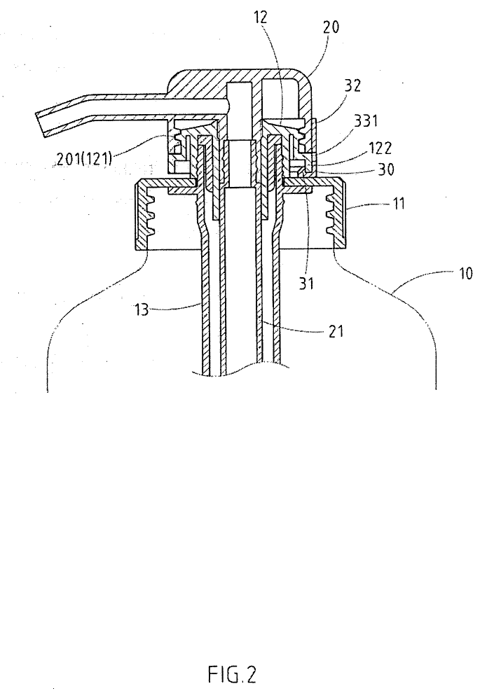

As shown in FIGS. 1-3, a preferred embodiment of the safeguard device for the liquid container pump, which has a piston rod 21 placed on the bottom of the pump 20, after inserting the piston rod 21 through the bottle cap 11 of the container 10, and connected to the joint cap 12 on the top, then insert it into the cylinder 13 on the bottom of the bottle cap 11, and a spring is placed between the bottom of the cylinder 13 and the pump 20, using the spring to support the springing condition for the pump 20; it offers the elastic pressure control and restoring function for the pump 20 and piston rod 21, and the inner and outer screw threads 201 121 are placed inside the inner diameter of the pump 20 and outside the outer diameter of the joint cap 12 and corresponding to each other, so that when the pump is pressed, the inner screw thread 21 will be locked to the outer screw thread 121 of the joint cap 12, and the pump 20 will not be pushed up by the spring (not shown); the bottom of the piston rod 21 pushed against a reverse stopper (not shown) placed on the hole 131 on the bottom of the cylinder 13, so that the cleaner inside will not come out, which makes the pump of the liquid container stay unopened; and to maintain the pump's locking position, the present invention designs a safeguard device. It is to place a substrate 30 with proper size, and it is better if the height of the substrate 30 does not exceed the locking line of the pump 20 and the joint cap 12, and the bottom edge of the substrate 30 has a fastener 31 that faces inward, and using the fastener 31 to connect to bottom edge of the external ring 122 of the joint cap 12, which connects the substrate 30 to the edge of the joint cap 12; and a preset positioning chip 32 is placed on the substrate 30, and the connection between the substrate and positioning chip has several spaced holes 331 to form a disconnected line 33, and under the effect of the bigger outer force, the disconnected line 33 will break and separate the substrate 30 and the positioning chip 32, however, under the locking relationship between the pump 20 and the locking cap 12, in order to maintain the locking position of the pump 20, it uses high frequency heat fusion or glue to connect the substrate 30 and positioning chip 32 to the joint cap 21 and pump 20, this way, before the disconnected line is broken to connect to the substrate 30 and the positioning chip 21, it can avoid the pump 20 being easily opened by the consumers, and once the pump is opened forcefully, the disconnected line 33 will break and cause the separation of the substrate 30 and the positioning chip 32; and after the substrate 30 is separated with the positioning chip 32, it can not restore to the connecting status, with the substrate 30 and the positioning chip 32 are being placed on the outside of joint cap 12 and the pump 20, therefore, the consumer can tell if the pump of the container 10 has been opened by whether or not the substrate 30 and the positioning chip 32 are broken, which can be a concern when shopping and further effectively protect the consumer's rights of not purchasing the new product that has been opened.

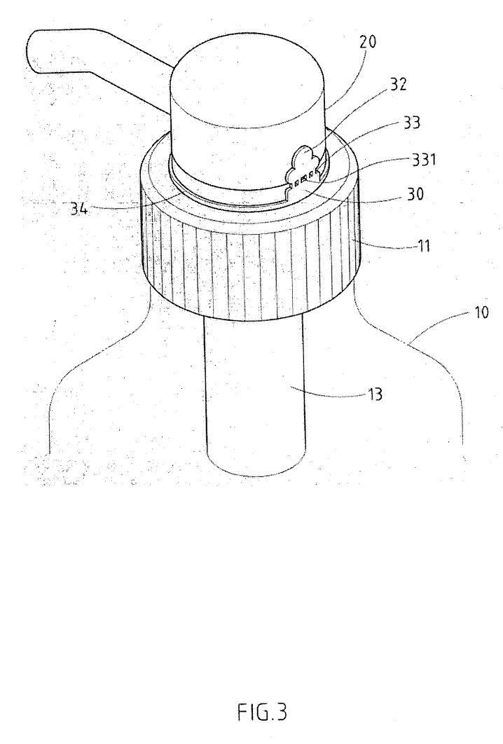

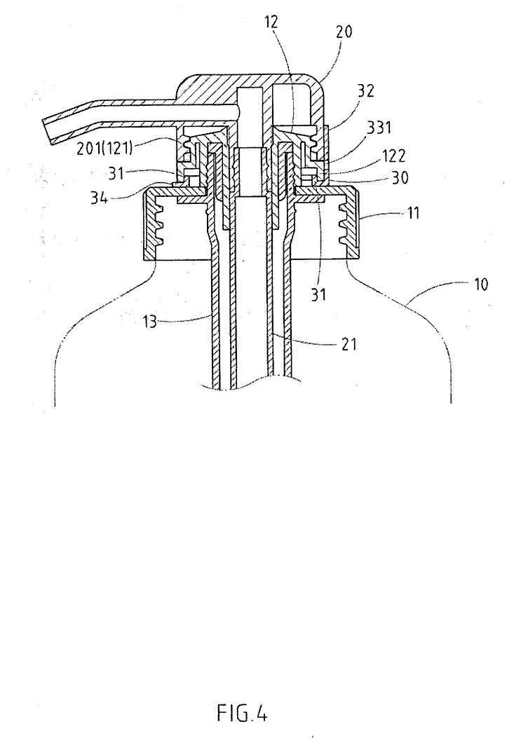

FIGS. 3 and 4 show another preferred embodiment of the present invention, as shown in the figure, the pump 20, bottle cap 11, joint cap 12, cylinder 13, piston rod 21 and spring of the liquid container 10 do not have too big of change, the difference is a complete ring 34 placed on the bottom of the substrate 30, and using the ring 34 to tie the substrate 30 to the external ring 122 of the joint cap 12, meanwhile, the bottom edge of the ring 34 form a fastener 31 that faces inward, which fastens the fastener 31 to the bottom edge of the external ring 122 of the joint cap 12, so that ring 34 does not separate from the external ring 122 of the joint cap 12, and the top of the substrate 30 has a positioning chip 32 on the top of the substrate 30, and a disconnected line 33 is placed between the substrate 30 and the positioning chip 32, and by connecting the substrate 30 and positioning chip 32 to the external ring 122 of the joint cap 12 and the pump, it can maintain the unopened state and not easily be opened, and once the pump 20 is opened, the substrate 30 and the positioning chip 32 will not be able to restore, therefore, it would be able to tell whether the pump 20 has been open.

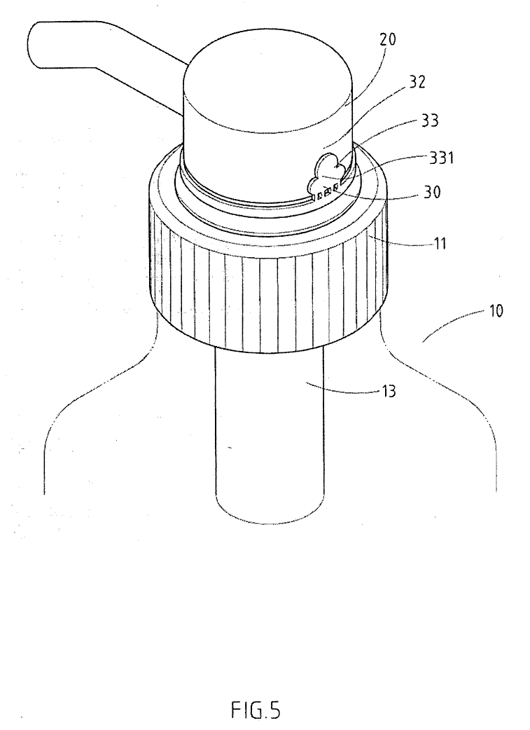

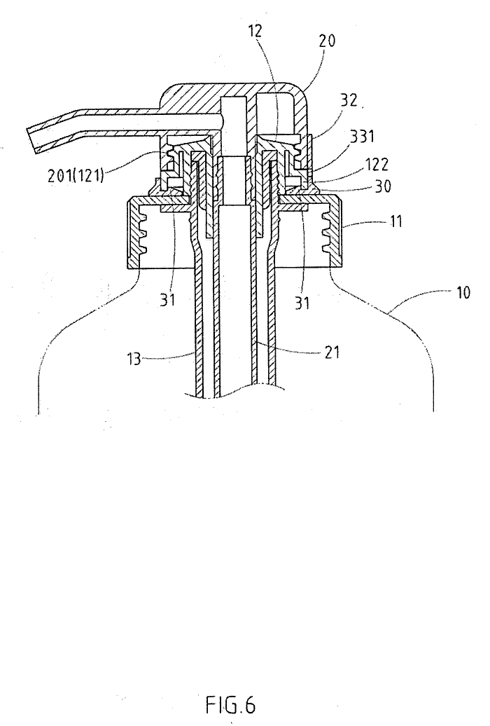

Also, FIGS. 5 and 6 shows another preferred embodiment of the present invention, as shown in the figure, the relations of the bottle cap11, joint cap 12, cylinder 13 and the pump 20, the piston rod 31 and the spring 32 remains the same, however, the substrate 30 is made like a ring, the bottom edge of the substrate 30 extends inward has fastener 31, and by connecting the substrate 30 to the external ring 122 of the joint cap 12, and makes the fastener 31 connect to the bottom edge of the external ring of joint cap 12, so that the substrate 30 does not separate from the joint cap 12, and the top edge of one side of the substrate 30 forms a positioning chip 32, and between the positioning chip 32 and substrate 30 places the same disconnected line 33, and the positioning chip 32 and the substrate 30 connects to the external ring 122 of the positioning chip 32 and substrate 30, and maintain the pump's 20 unopened condition, so, when the pump 20 is being opened forcefully, the positioning chip 32 and the substrate 30 will break off from the disconnected line 33 and unable to restore.

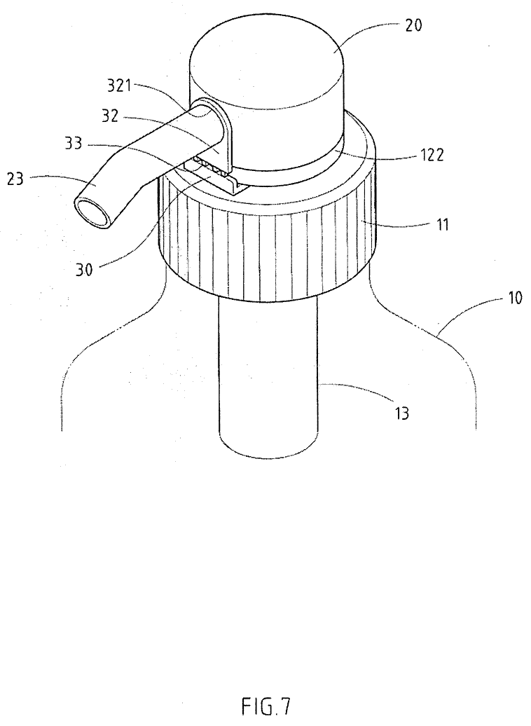

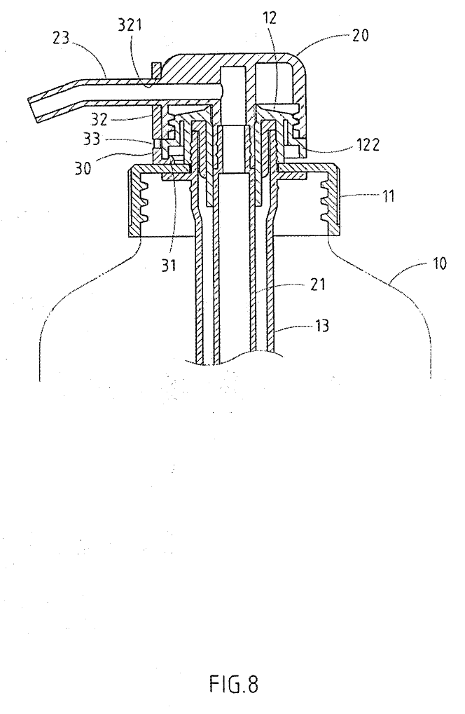

Also, FIGS. 7 and 8 show another preferred embodiment of the present invention, which is the connection of the pump 20 of the liquid container 10, insert the piston rod 21 at the bottom end of the pump 20 through into the cylinder 13 on the bottom of the bottle cap 11, and a spring is placed between the pump 20 and the bottom of the cylinder 13, and the joint cap 12 that is placed on top of the bottle cap 11 offers pump 20 to be locked, so that the pump 20 stays unopened; so as to maintain the relationship between the pump 20 and the joint cap 12, the bottom edge of the substrate 30 has a fastener 31 that can be fastened to the bottom edge of the external ring 122 of the joint cap 12; a position chip 32 in larger size is placed on top of the substrate 30, and the disconnected line 33 is placed between the positioning chip 32 and substrate 30, and a hole 321 is placed on the upper section of the positioning chip 32, and by restricting the positioning chip 32 to the pump's pressing tube 23 position to obtain the positioning relation between the positioning chip 32 and the pump 201; the substrate 30 uses high frequency heat fusion or glue to connect to the external ring 122 of the joint cap 12 and maintains the locking relation between the pump 20 and the joint cap 12, so that the pump 20 is not opened easily, and when the pump is being opened forcefully, the substrate 30 and its positioning chip 32 will break off from the disconnected line 33 and unable to restore, so that the consumer can easily tell whether the pump 20 has been opened.

Therefore, according to the above description we know that to maintain the unopened status of the pump of the liquid container, we can fasten or tie the substrate on the joint cap that is on top of the bottle cap of the container to the positioning chip on the top, and connect the substrate and the positioning chip to the joint cap and the pump as one, and by effectively maintain the unopened status of the pump and the connection set to restrict the consumers from opening the pump easily, and after the pump is opened, its substrate and positioning chip will break off and unable to restore to its original state, with the substrate and the positioning chip being placed on the outside, not only the structure is pretty simple, it is more convenient on the assembly as well, in the meantime, it is easy for the consumer to tell whether or not the pump has been opened, which effectively protect the consumer's rights to purchase new product, and further reduce the consumer disputation, overall, it has great industrial value and practicability.

To sum up, the safeguard device for the pump of the liquid container can be fastened or tied to the substrate of the joint cap on top of the bottle cap of the container and the positioning chip on the top, and connected to the joint cap and pump to maintain the locking relation between the pump and joint cap, on one hand, it can avoid the pump being opened improperly, on the other hand, it shows whether the pump has been opened improperly; the structure is simple and easy to assemble, which can effectively solve many issues existed in the conventional design. Overall, it has the industrial value and practicability, and with the new design, the patent may be applied according to the laws.

1. A safeguard device for a liquid container pump, said pump having a piston rod placed on a bottom of the pump, after inserting the piston rod through a bottle cap of a container, and connected to a joint cap on a top of the container, said piston rod being inserted into a cylinder on a bottom of the bottle cap, a spring being placed between the bottom of the cylinder and the pump, using the spring to support a springing condition for the pump; said spring offering elastic pressure control and restoring function for the pump and piston rod, inner and outer screw threads being placed inside an inner diameter of the pump and outside an outer diameter of the joint cap and corresponding to each other, so that when the pump is pressed, the inner screw thread will be locked to the outer screw thread of the joint cap, and the pump will not be pushed up by the spring; the bottom of the piston rod pushing against a reverse stopper placed on a hole on the bottom of the cylinder, so that a cleaner inside the container will not come out, making the pump of the liquid container stay unopened; said safeguard device comprising:
a substrate being fastenable to an external ring of the joint cap, and having a fastener on a bottom thereof that faces inward, said fastener connecting to a bottom edge of the external ring of the joint cap, connecting the substrate to an edge of the joint cap; and
a preset positioning chip placed on the substrate, the connection between the substrate and positioning chip having several spaced holes to form a disconnected line, the positioning chip and the substrate connecting to the external ring on the joint cap and pump;
wherein, when the disconnected line has not yet broken and under relation between the substrate and the positioning chip, the container can avoid being opened, and wherein, once the pump is opened forcefully, the disconnected line breaks and causes separation of the substrate and the positioning chip, forming a sign to show whether the pump has been opened.

2. A safeguard device for a liquid container pump, said pump having a piston rod placed on a bottom of the pump, after inserting the piston rod through a bottle cap of a container, and connected to a joint cap on a top of the container, said piston rod being inserted into a cylinder on a bottom of the bottle cap, a spring being placed between the bottom of the cylinder and the pump, using the spring to support a springing condition for the pump; said spring offering elastic pressure control and restoring function for the pump and piston rod, inner and outer screw threads being placed inside an inner diameter of the pump and outside an outer diameter of the joint cap and corresponding to each other, so that when the pump is pressed, the inner screw thread will be locked to the outer screw thread of the joint cap, and the pump will not be pushed up by the spring; the bottom of the piston rod pushing against a reverse stopper placed on a hole on the bottom of the cylinder, so that a cleaner inside the container will not come out, making the pump of the liquid container stay unopened; said safeguard device comprising:
a substrate being fastened to an external ring of a joint cap, and having a complete ring on a bottom thereof placed on the bottom of the substrate, the ring tying said substrate to the external ring of the joint cap, a bottom edge of the ring forming a fastener that faces inward, which fastens the fastener to the bottom edge of the external ring of the joint cap, so that ring forming a fastener does not separate from the external ring of the joint cap,
a positioning chip on a top of the substrate, and
a disconnected line placed between the substrate and the positioning chip, connecting the substrate and positioning chip to the external ring of the joint cap and the pump;
wherein the disconnected line has not yet broken and under relation between the substrate and the positioning chip, said container can avoid being opened, and wherein once the pump is opened forcefully, the disconnected line breaks and causes separation of the substrate and the positioning chip, forming a sign to show whether the pump has been opened.

3. A safeguard device for a liquid container pump, said pump having a piston rod placed on a bottom of the pump, after inserting the piston rod through a bottle cap of a container, and connected to a joint cap on a top of the container, said piston rod being inserted into a cylinder on a bottom of the bottle cap, a spring being placed between the bottom of the cylinder and the pump, using the spring to support a springing condition for the pump; said spring offering elastic pressure control and restoring function for the pump and piston rod, inner and outer screw threads being placed inside an inner diameter of the pump and outside an outer diameter of the joint cap and corresponding to each other, so that when the pump is pressed, the inner screw thread will be locked to the outer screw thread of the joint cap, and the pump will not be pushed up by the spring; the bottom of the piston rod pushing against a reverse stopper placed on a hole on the bottom of the cylinder, so that a cleaner inside the container will not come out, making the pump of the liquid container stay unopened; said safeguard device comprising:
a substrate being fastened to an external ring of a joint cap, and having a complete ring on a bottom of the substrate placed on the bottom of the substrate, a bottom edge of the substrate being a fastener, connecting the substrate to the external ring of the joint cap to make said fastener connect to the bottom edge of the external ring of joint cap, so that the substrate does not separate from the joint cap,
a positioning clip formed on a top edge of one side of the substrate, and
a preset positioning chip placed on the substrate, a connection between the substrate and positioning chip having several spaced holes to form a disconnected line, the positioning chip and the substrate being connected to the external ring on the joint cap and pump;
wherein when the disconnected line has not yet broken and under relation between the substrate and the positioning chip, the container can avoid being opened, and wherein once the pump is opened forcefully, the disconnected line breaks and causes separation of the substrate and the positioning chip, forming a sign to show whether the pump has been opened.

4. A safeguard device for a liquid container pump, said pump having a piston rod placed on a bottom of the pump, after inserting the piston rod through a bottle cap of a container, and connected to a joint cap on a top of container, said piston rod being inserted into a cylinder on a bottom of the bottle cap, a spring being placed between the bottom of the cylinder and the pump, using the spring to support a springing condition for the pump; said spring offering elastic pressure control and restoring function for the pump and piston rod, inner and outer screw threads being placed inside an inner diameter of the pump and outside an outer diameter of the joint cap and corresponding to each other, so that when the pump is pressed, the inner screw thread will be locked to the outer screw thread of the joint cap, and the pump will not be pushed up by the spring; the bottom of the piston rod pushing against a reverse stopper placed on a hole on the bottom of the cylinder, so that a cleaner inside the container will not come out, making the pump of the liquid container stay unopened; said safeguard device comprising:
a substrate being fastened to an external ring of a joint cap, and having a fastener on a bottom of the substrate facing inward and being connected to a bottom edge of the external ring of the joint cap;
a position chip in larger size being placed on top of the substrate,
a disconnected line placed between the positioning chip and substrate, and
a hole placed on an upper section of the positioning chip, restricting the positioning chip to a pressing tube position of the pump to obtain a positioning relation between the positioning chip and the pump;
wherein the substrate uses high frequency heat fusion or glue to connect to the external ring of the joint cap and maintains the locking relation between the pump and the joint cap, so that the pump is not opened, and when the pump is being opened forcefully, the substrate and positioning chip break off from the disconnected line and become unable to restore, forming a sign to tell whether the pump has been opened.

5. The structure defined in claim 1, wherein height of said substrate does not exceed the locking line for the pump and joint cap.

6. The structure defined in claim 1, wherein said substrate and positioning chip use high frequency heat fusion to be connected to the joint cap and pump.

7. The structure defined in claim 1, wherein said substrate and positioning chip use glue to be connected to the joint cap and pump.
